(19) United States
(12) Patent Application Publication
(10) Pub. No.: US 2023/0030400 A1
(43) Pub. Date: Feb. 2, 2023

(54) GUIDE FOR A SEALANT APPLICATOR NOZZLE

(71) Applicant: Alan Francis DALE, Taunton (GB)

(72) Inventor: Alan Francis DALE, Taunton (GB)

(21) Appl. No.: 17/386,676

(22) Filed: Jul. 28, 2021

(51) Int. Cl. B05C 17/005

(52) U.S. Cl. CPC B05C 17/0052; B05C 17/00596

(57) ABSTRACT

A guide for a sealant applicator nozzle. The guide can include a base portion couplable to the sealant applicator nozzle, and a bearing element having a bearing surface. At least a portion of the bearing surface can face the sealant applicator nozzle, and a lateral distance between the bearing surface and the sealant applicator nozzle can be variable. The bearing element may be rotatable with respect to the base portion, and may be eccentrically rotatable with respect to a central longitudinal axis of the bearing element. The guide can include a post coupled to the base portion and the bearing. The guide can further include an aperture defined in the base portion, the sealant applicator nozzle being receivable within the aperture.

### BACKGROUND

In certain situations where a sealant needs to be applied between two bodies to be joined, the sealant bead frequently needs to be applied carefully such that the bead is positioned in the appropriate joining location between the two bodies, and such that the bead is not exposed outside the joining location. For example, when replacing a damaged windshield, the adhesive bead is laid down in a strip on the windshield glass, at a location where the bead will be disposed exactly between the windshield glass and the body of the vehicle. As the portion of the vehicle body that supports the windshield is typically narrow, the bead must be laid down as a linear strip at a predetermined distance from the perimeter edge of the windshield glass, with little margin of error for deviation from such distance.

Typically, in windshield installation, the installer uses his or her dexterity and concentration to apply the adhesive bead as needed. However, if, at any point, such dexterity and concentration becomes insufficient, a deviation from the needed distance from the perimeter edge of the windshield glass, or a poor bead quality of the applied adhesive can result. A solution for accurately applying the adhesive bead in a controlled manner is therefore desired.

### SUMMARY

According to at least one exemplary embodiment, a guide for a sealant applicator nozzle is disclosed. The guide can include a base portion couplable to the sealant applicator nozzle, and a bearing element having a bearing surface. At least a portion of the bearing surface can face the sealant applicator nozzle, and a lateral distance between the bearing surface and the sealant applicator nozzle can be variable. The bearing element may be rotatable with respect to the base portion, and may be eccentrically rotatable with respect to a central longitudinal axis of the bearing element. The guide can include a post coupled to the base portion and the bearing. The guide can further include an aperture defined in the base portion, the sealant applicator nozzle being receivable within the aperture.

According to another exemplary embodiment, the guide can include a base portion having an aperture for receiving the sealant applicator nozzle, a post having a first end and a second end, the first end being coupled to the base portion, and a bearing element coupled to the second end of the post, the bearing element having a bearing surface, at least a portion of the bearing surface facing the sealant applicator nozzle. The bearing element can be eccentrically rotatable with respect to a central longitudinal axis of the post. A lateral distance between the bearing surface and a tip of the sealant applicator nozzle can be variable.

According to another exemplary embodiment, a method of applying sealant using a sealant applicator nozzle, is disclosed. The method can include providing, coupled to the nozzle, a guide having a bearing element, adjusting a lateral distance between a tip of the nozzle and a bearing surface of the bearing element, placing the tip of the nozzle against a surface to which sealant is to be applied, placing the bearing element such that the bearing element bears against an edge of a structure proximate the surface, and applying the sealant to the surface as the bearing element bears against the edge. At least a portion of the bearing surface can face the nozzle. A distance between the tip of the nozzle and the edge can correspond to the lateral distance between the tip of the nozzle and the portion of the bearing surface facing the nozzle. Adjusting the lateral distance can include eccentrically rotating the bearing element.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows an exemplary embodiment of a guide for a sealant applicator nozzle.

FIG. 2 is an exploded view of the exemplary embodiment of a guide for a sealant applicator nozzle.

FIG. 3 shows the exemplary embodiment of the guide coupled to a sealant applicator nozzle.

FIG. 4a shows the exemplary embodiment of the guide with the bearing element in a first exemplary position.

FIG. 4b shows the exemplary embodiment of the guide with the bearing element in a second exemplary position.

FIG. 5a shows the exemplary embodiment of the guide in use, with the bearing element in a third exemplary position.

FIG. 5b shows the exemplary embodiment of the guide in use, with the bearing element in a fourth exemplary position.

FIG. 6 shows an exemplary embodiment of a sealant applicator nozzle with integrated guide.

### DETAILED DESCRIPTION

Aspects of the invention are disclosed in the following description and related drawings directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

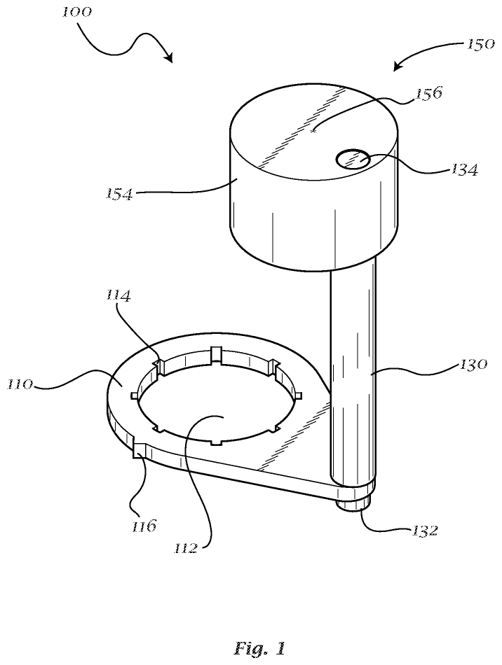

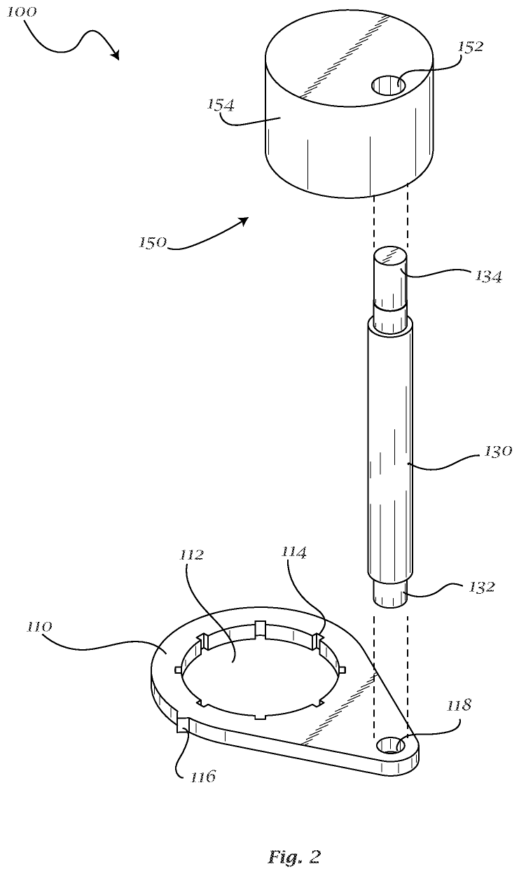

According to at least one exemplary embodiment, and as shown in FIGS. 1-3, a guide 100 for a sealant applicator nozzle 10 is disclosed. Guide 100 can include a base portion 110, a post 130 coupled to base portion 110, and a bearing element 150 eccentrically coupled to post 130. When coupled to a sealant applicator nozzle, base portion 110 may engage the sealant applicator nozzle, while bearing element 150 may be positioned proximate, in a height direction, to the tip of the nozzle, and offset, in a lateral direction, from the tip of the nozzle.

In one exemplary embodiment, base portion 110 may be substantially planar and may include a nozzle coupling aperture 112. Nozzle coupling aperture 112 may be sized and shaped to couple to one or more known nozzles 10, for example such nozzles as commonly used to apply sealants, caulks, adhesives, glues, and so forth. Nozzle coupling aperture 112 may therefore be provided in a variety of sizes. Nozzle coupling aperture 112 may further include a plurality of notches 114 defined in the perimeter of the nozzle coupling aperture. Notches 114 may be sized and shaped to engage corresponding ribs 14 disposed around the circumference of nozzle 10, and can function to prevent rotation of nozzle 10 within aperture 112. Base portion 110 may further include an indicator 116, which may be provided, for example, as an angular protrusion on the external perimeter surface of base portion 110. In the exemplary embodiment, base portion 110 has a substantially a teardrop-like shape, with aperture 112 located at a larger-diameter end of base portion 110, and post 130 located at a smaller-diameter end of base portion 110; however, any shape for base portion 110 that enables guide 100 to function as described herein may be contemplated and provided as desired.

Base portion 110 may be coupled to post 130 in any known manner that enables guide 100 to function as described herein. For example, in one exemplary embodiment, a first end 132 of post 130 may be received within an aperture 118 of base portion 110; in other exemplary embodiments, the first end 132 of post 130 may be received within a recess defined on base portion 110, or may otherwise be coupled to base portion 110. Coupled to a second end 134 of post 130 may be bearing 150. Bearing element 150 may be coupled to post 130 in any known manner that enables guide 100 to function as described herein. For example, in one exemplary embodiment, the second end 134 of post 130 may be received within an aperture 152 of bearing element 150; in other exemplary embodiments, the second end 134 of post 130 may be received within a recess defined in bearing element 150, or may otherwise be coupled to bearing element 150.

It should be appreciated that bearing element 150 may be rotatable with respect to base portion 110, and therefore, the couplings of post 130 may be provided in any manner that enables such functionality. In other words, bearing element 150 may be rotatably coupled to post 130 and post 130 may be fixedly coupled to base portion 110, bearing element 150 may be fixedly coupled to post 130 and post 130 may be rotatably coupled to base portion 110, or post 130 may be rotatably coupled to both bearing element 150 and base portion 110. It should further be appreciated that these rotatable couplings may not be freely rotatable, but only rotatable upon an application of sufficient force, for example when rotated by hand. The rotatable couplings may therefore have a friction or interference fit, such that, without application of sufficient force, the position of bearing 150 relative to base portion 110 is static and maintained.

Bearing element 150 may include a bearing surface 154, which, in some embodiments, may be a circumferential surface of bearing element 150. Bearing surface 154 may be oriented in a plane that is substantially parallel to the longitudinal axis of post 130. Furthermore, at least a portion of bearing surface 154 may be oriented such that it is facing tip 12 of nozzle 10 when guide 100 is coupled to the nozzle. In the exemplary embodiment, bearing 150 has a substantially cylindrical shape with bearing surface 154 being the lateral surface of the cylinder; however any shape for bearing element 150 that enables guide 100 to function as described herein may be contemplated and provided as desired.

Bearing element 150 may further be eccentrically coupled to post 130 such that the central longitudinal axis of post 130 and the parallel-thereto central longitudinal axis 156 of bearing element 150 are not collinear. In other words, post 130 may be coupled to bearing element 150 at a location disposed between the central longitudinal axis 156 of bearing element 150 and the bearing surface 154 of bearing 150.

In operation, guide 100 may be coupled to a nozzle 10 by inserting nozzle 10 into coupling aperture 112 until a friction fit exists between nozzle 10 and the perimeter of aperture 112. Nozzle 10 may be oriented such that a V-cut 16 of the nozzle is aligned with indicator 116 of the base portion. If present, ribs 14 of the nozzle may be received within notches 114 of the coupling aperture. Accordingly, a snug and secure fit of the nozzle within the coupling aperture may be maintained.

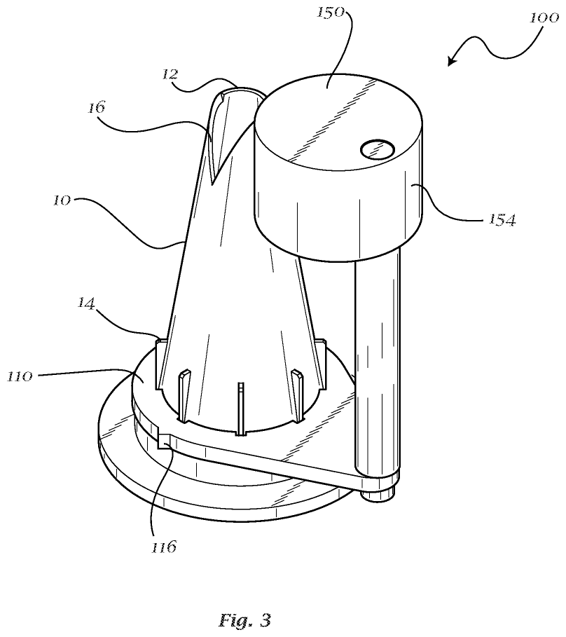

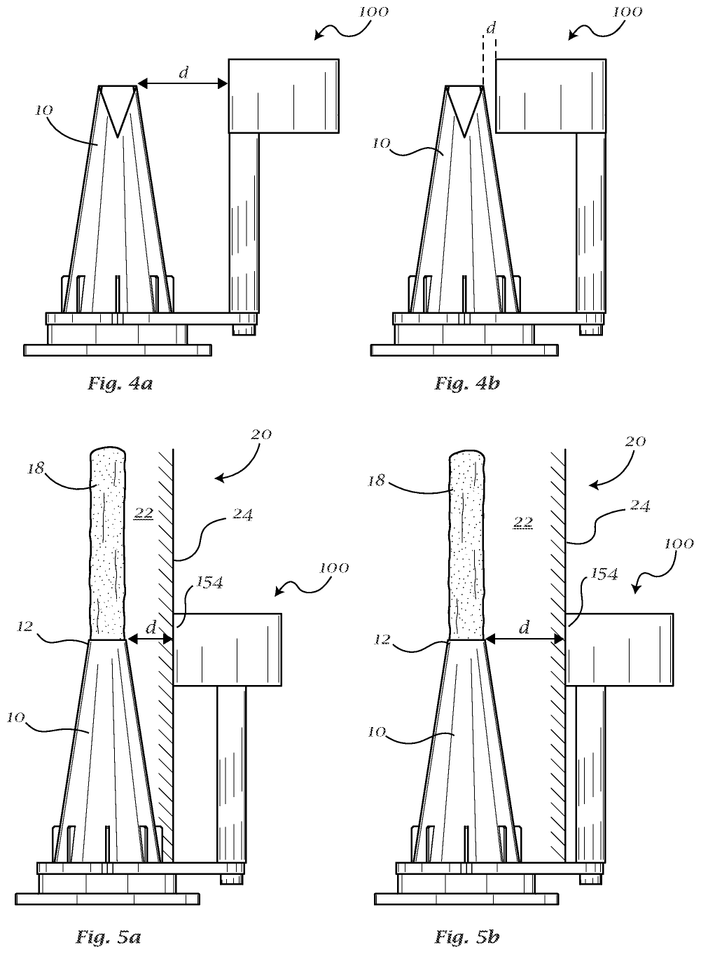

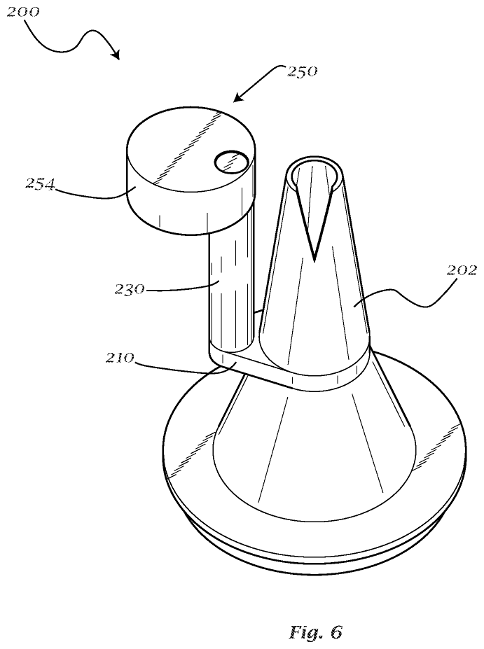

Bearing element 150 may then be rotated with respect to base portion 110 to a desired position. As a consequence of the eccentric coupling of bearing element 150, the lateral distance d between the tip 12 nozzle 10 and bearing surface 154 can vary continuously depending on the rotational position of the bearing. FIGS. 4a-4b show two exemplary positions of the bearing element that may be achieved by rotating the bearing element. A desired lateral distance d between the nozzle tip 12 and the bearing surface 154 may thus be achieved. After the desired lateral distance d is achieved, the tip 12 of nozzle 10 may be placed on a surface to which sealant may be applied, while the bearing surface 154 may be placed so as to bear on an edge of a structure proximate to the surface to which sealant may be applied. The nozzle 12 may be placed such that the V-cut 14 of the nozzle faces the surface to which sealant may be applied, thereby allowing a sufficient depth of the sealant bead to be applied to the surface. The nozzle can then be moved and the sealant bead applied, while the bearing surface bears against the edge, facilitating an accurate application of the bead at the desired distance from the edge. For example, if it is desired to apply an adhesive bead 18 to a vehicle windshield 20, the tip 12 of the nozzle may be placed against the planar surface 22 of the windshield glass, while the bearing surface 154 may be placed against the perimeter edge 24 of the windshield glass. As the nozzle 10 is continuously moved so as to apply the sealant bead 18, the bearing surface 154 continues to bear against the perimeter edge 24 of the windshield, thereby ensuring that the adhesive bead 18 is neatly laid down and that a desired distance between the adhesive bead 18 and the windshield edge 24 is maintained. FIGS. 5a-5b show an exemplary method of applying an adhesive bead, wherein, due to differing lateral distances d, the bead is applied at differing distances from the perimeter edge of the windshield.

FIG. 6 shows an exemplary embodiment of an integrated nozzle and guide 200. The integrated nozzle and guide can include a nozzle body 202, a guide base portion 210 connecting guide post 230 to nozzle body 202, and a guide bearing 250 rotatably and eccentrically coupled to guide post 230. The nozzle body 202, guide base portion 210, and guide post 230 may be formed integrally as a unit, for example by injection molding or by any other process. Guide bearing 250 may be formed separately from the integrally-formed components so as to allow guide bearing 250 to rotate on post 230. The rotatable coupling between guide bearing 250 and post 230 may not be freely rotatable, but only rotatable upon an application of sufficient force, for example when rotated by hand. The rotatable coupling may therefore have a friction or interference fit, such that, without application of sufficient force, the position of guide bearing 250 relative to nozzle 202 is maintained and static. The functionality and use of integrated nozzle and guide 200 may be substantially the same as that of the embodiment of guide 100 when coupled to nozzle 20, as described above.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A guide for a sealant applicator nozzle, comprising:
a base portion couplable to the sealant applicator nozzle; and
a bearing element having a bearing surface;
wherein at least a portion of the bearing surface faces the sealant applicator nozzle; and
wherein a lateral distance between the bearing surface and the sealant applicator nozzle is variable.

2. The guide of claim 1, wherein the bearing element is rotatable with respect to the base portion.

3. The guide of claim 2, wherein the bearing element is eccentrically rotatable with respect to a central longitudinal axis of the bearing element.

4. The guide of claim 2, further comprising a post coupled to the base portion and to the bearing.

5. The guide of claim 1, further comprising a post coupled to the base portion and to the bearing.

6. The guide of claim 5, wherein the post is rotatably coupled to the bearing.

7. The guide of claim 5, wherein the post is rotatably coupled to the base portion.

8. The guide of claim 1, further comprising an aperture defined in the base portion, the sealant applicator nozzle being receivable within the aperture.

9. The guide of claim 8, further comprising at least one notch defined in a perimeter of the aperture.

10. The guide of claim 1, the base portion further comprising an indicator.

11. The guide of claim 1, wherein the lateral distance is continuously variable.

12. The guide of claim 1, wherein at least a portion of the bearing surface faces a tip of the sealant applicator nozzle.

13. A sealant applicator nozzle comprising the guide of claim 1.

14. A guide for a sealant applicator nozzle, comprising:
a base portion having an aperture for receiving the sealant applicator nozzle;
a post having a first end and a second end, the first end being coupled to the base portion; and
a bearing element coupled to the second end of the post, the bearing element having a bearing surface, at least a portion of the bearing surface facing the sealant applicator nozzle;
wherein the bearing element is eccentrically rotatable with respect to a central longitudinal axis of the post.

15. The guide of claim 14, wherein a lateral distance between the bearing surface and a tip of the sealant applicator nozzle is variable.

16. A sealant applicator nozzle comprising the guide of claim 14.

17. A method of applying sealant using a sealant applicator nozzle, comprising:
providing, coupled to the nozzle, a guide having a bearing element;
adjusting a lateral distance between a tip of the nozzle and a bearing surface of the bearing element;
placing the tip of the nozzle against a surface to which sealant is to be applied;
placing the bearing element such that the bearing element bears against an edge of a structure proximate the surface; and
applying the sealant to the surface as the bearing element bears against the edge;
wherein at least a portion of the bearing surface faces the nozzle.

18. The method of claim 17, wherein a distance between the tip of the nozzle and the edge corresponds to the lateral distance between the tip of the nozzle and the portion of the bearing surface facing the nozzle.

19. The method of claim 17, wherein adjusting the lateral distance comprises eccentrically rotating the bearing element.

20. The method of claim 17, wherein the surface is a vehicle windshield.
